(19) United States
(12) Patent Application Publication
(10) Pub. No.: US 2019/0164654 A1
(43) Pub. Date: May 30, 2019

(54) NUCLEAR POWER PLANTS

(71) Applicant: ROLLS-ROYCE plc, London (GB)

(72) Inventor: James C. PALMER, Derby (GB)

(73) Assignee: ROLLS-ROYCE plc, London (GB)

(21) Appl. No.: 16/184,606

(22) Filed: Nov. 8, 2018

(30) Foreign Application Priority Data
Nov. 23, 2017 (GB) 1719431.7

(51) Int. Cl. G21C 15/18; G21C 15/02

(52) U.S. Cl. CPC G21C 15/18; G21C 15/02

(57) ABSTRACT

A nuclear power plant, having a reactor pressure vessel; a steam generator arranged to generate steam utilising thermal energy generated within the reactor pressure vessel; and a fluid circuit for transferring thermal energy from the reactor pressure vessel to the steam generator. The plant also has a coolant reservoir for storing coolant for supply to the steam generator under gravity in emergency conditions. The steam generator has a steam drying zone comprising one or more steam separators configured to dry steam; and the steam generator and coolant reservoir are configured such that when coolant is supplied from the coolant reservoir to the steam generator in emergency conditions the coolant stays below a threshold level defined by the steam drying zone.

### CROSS-REFERENCE TO RELATED APPLICATIONS

This specification is based upon and claims the benefit of priority from UK Patent Application Number 1719431.7 filed on 23 Nov. 2017, the entire contents of which are incorporated herein by reference.

### TECHNOLOGICAL FIELD

The present disclosure relates to nuclear power plants.

### BACKGROUND

A nuclear power plant typically includes a nuclear reactor, a primary circuit, a heat exchanger, a secondary circuit, and a turbine. The primary fluid in the primary circuit is heated by the nuclear reactor. The primary fluid flows to the heat exchanger, where it heats secondary fluid in the secondary circuit. The heated secondary fluid is then used to drive the turbine to generate electricity.

It is important that the nuclear reactor and fuel does not overheat as this could result in catastrophic failure. As such, it is necessary to provide cooling to the reactor. Generally, cooling is provided in operation by the circulation of heat in the primary fluid (or coolant) of the primary circuit, exchanging that heat with the secondary cooling system via the heat exchanger (e.g. steam generator or boiler) and then exchanging this heat with an ultimate heat sink of the power station. The ultimate heat sink may be the sea, a cooling tower, or some other alternative heat sink.

It is important that a nuclear power plant includes safety systems such that if there is a failure (e.g. no electricity) meaning that the usual cooling flow described above is not available, the reactor is prevented from overheating in its shutdown state, where the reactor will still be generating substantial heat in the form of decay heat.

### BRIEF SUMMARY

According to an aspect there is provided a nuclear power plant, comprising: a reactor pressure vessel; a steam generator arranged to generate steam utilising thermal energy generated within the reactor pressure vessel; a fluid circuit for transferring thermal energy from the reactor pressure vessel to the steam generator; and a coolant reservoir for storing coolant for supply to the steam generator under gravity in emergency conditions; wherein the steam generator comprises a steam drying zone comprising one or more steam separators configured to dry steam; and wherein the steam generator and coolant reservoir are configured such that when coolant is supplied from the coolant reservoir to the steam generator in emergency conditions the coolant stays below a threshold level defined by the steam drying zone.

The threshold level may be set such that, provided that the coolant stays below the threshold level, the or each or at least some of the steam separators function to dry steam within the steam generator. The threshold level may be set such that, provided that the coolant in the secondary side of the steam generator stays below the threshold level, the or each or at least some of the steam separators function to dry steam within the steam generator. The threshold level may be defined by a lower limit of the steam drying zone. The steam drying zone may be defined as the region within which steam drying occurs, or the operable range of the or each steam separator. The or each steam separator may at least partially lie within the steam drying zone.

The coolant reservoir may contain coolant such as water. The level of the coolant within the coolant reservoir may be at or below the threshold level. The coolant reservoir may be located inside a reactor containment. The coolant reservoir may circumferentially surround the steam generator, reactor arrangement or reactor containment structure.

The coolant reservoir may be provided with a valve, such as a breather valve, operable to provide fluid communication between the coolant reservoir and the outside thereof. The power plant may further comprise a depressurisation valve operable to reduce the pressure within the steam generator. The depressurisation valve may be operable to route steam to a subsidiary location. The power plant may further comprise a feed conduit between the coolant reservoir and the steam generator. The feed conduit may be provided with a valve operable to allow fluid communication between the coolant reservoir and the steam generator.

There is also disclosed a method of operating a nuclear power plant in accordance with any statement herein, the method comprising supplying coolant from the coolant reservoir to the steam generator under gravity, the coolant remaining below a threshold level defined by the steam drying zone.

The method may further comprise opening a valve so as to provide fluid communication between the coolant reservoir and the outside thereof. The method may further comprise opening a depressurisation valve so as to reduce the pressure within the steam generator. Opening the depressurisation valve may route steam to a subsidiary location.

The invention may comprise any combination of the features and/or limitations referred to herein, except combinations of such features as are mutually exclusive.

### BRIEF DESCRIPTION

Embodiments of the invention will now be described, by way of example, with reference to the accompanying drawings, in which:

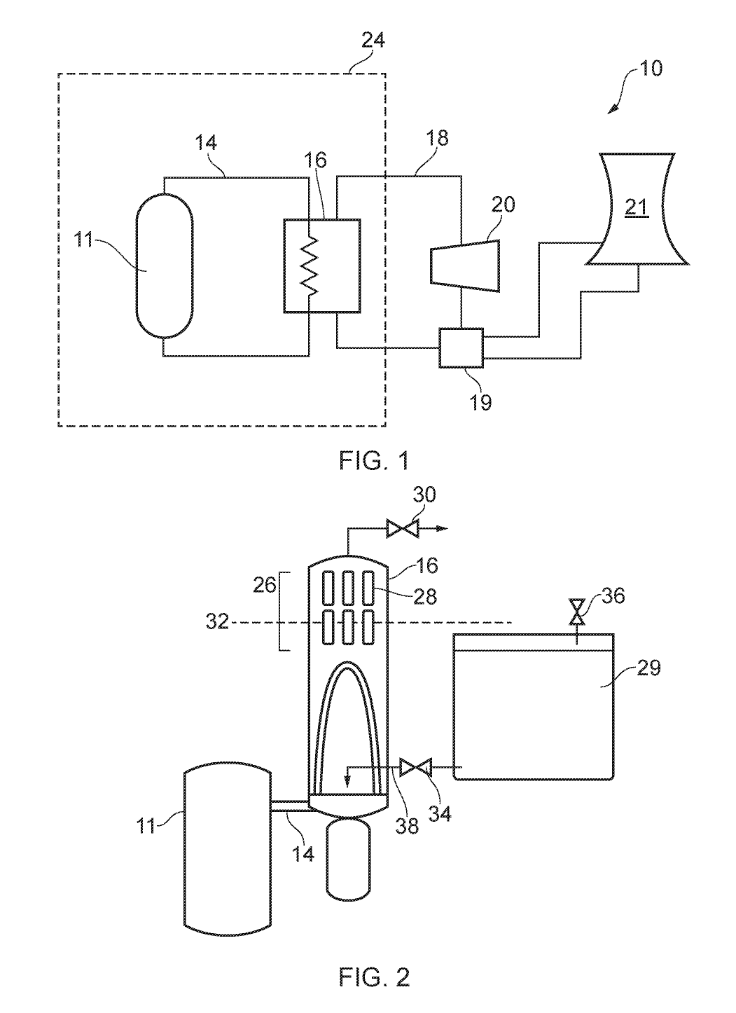

FIG. 1 schematically shows a nuclear power plant;

FIG. 2 schematically shows the reactor chamber of FIG. 1; and

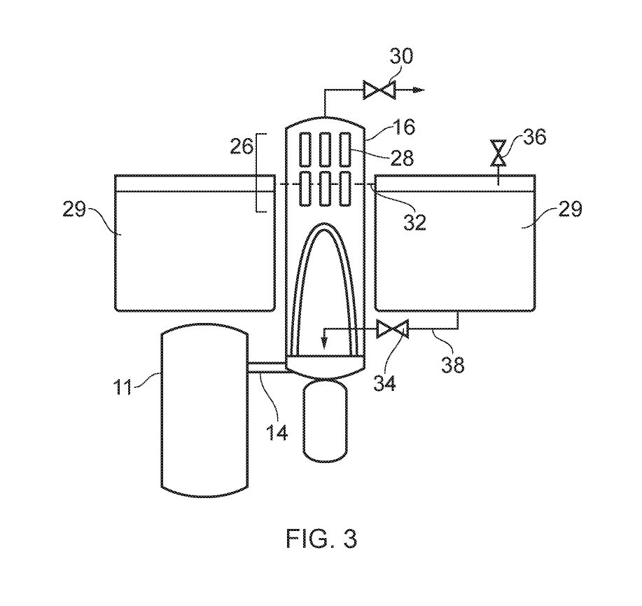

FIG. 3 schematically shows a reactor chamber in accordance with an alternative arrangement.

### DETAILED DESCRIPTION

Referring to FIG. 1, a nuclear power plant is indicated generally at 10. The plant includes a reactor pressure vessel (RPV) 11 housing nuclear fuel, a primary fluid circuit 14, a heat exchanger which in this example is a steam generator 16, a secondary fluid circuit 18 and a turbine 20. The turbine 20 is housed within a turbine hall (or building or chamber) (not shown) and the reactor vessel 11 is housed within a reactor chamber 24 (or building or hall). The reactor chamber 24 is separated from the turbine hall by a containment barrier. The barrier may be made, for example, from concrete and/or steel.

During normal operation of the nuclear power plant 10, the primary fluid in the primary circuit 14 is heated by the thermal energy generated in the reactor pressure vessel 11. The primary fluid then flows to the steam generator 16, where it heats the secondary fluid, which in this example is water, to generate steam. The generated steam is then used to drive the turbine 20, thereby generating electricity. The secondary fluid flows to a condenser 19 where it is cooled using water from an ultimate heat sink 21. The ultimate heat sink may be a cooling tower, river, lake, or any other suitable supply of cooling water. In emergency conditions, for example, if there is a power outage, the secondary circuit pumps may stop operating, meaning that the water in the secondary fluid circuit 18 will not continue to flow, causing a build-up of heat in the reactor pressure vessel 11. It is therefore desirable to provide a means for heat removal over extended periods of time from the immediate shut down state through to thermal roll-over of a plant without any intervention or power requirements.

FIG. 2 shows a part of the nuclear power plant which, as will be described in detail below, includes a local ultimate heatsink 29 for removing heat from the primary fluid circuit (and therefore from the reactor pressure vessel 11) in an emergency (e.g. during a power outage). As shown, in the present arrangement the reactor is a close-coupled reactor which means that the steam generator 16 is closely coupled to the reactor pressure vessel 11. In particular, in this arrangement the steam generator 16 is adjacent to the reactor pressure vessel 11 and is both mechanically and fluidly connected to the reactor pressure vessel 11. Although only one steam generator 16 is shown, it should be appreciated that a plurality of steam generators 16 may be provided. The entire assembly of the reactor pressure vessel 11 and the steam generator 16 is housed in the reactor chamber 24 and positioned proximal to a base of the reactor chamber 24.

As shown in FIG. 2, the steam generator 16 comprises two substantially horizontal arrays of steam separators 28, one located above the other in an upper region of the steam generator 16. The steam separators 28 are configured to dry the steam generated within the steam generator 16 such that water droplets are removed from vapour, thereby generating substantially dry steam. Substantially dry steam may be considered to be steam that contains less than 5% liquid water, or less than 4% liquid water, or less than 3% liquid water, or less than 2% liquid water, or less than 1% liquid water, or less than 0.5% liquid water, or less than 0.25% liquid water. The steam separators 28 therefore ensure that substantially dry steam is fed to the turbine 20. This may be highly desirable as wet steam can damage turbines and it carries less energy than dry steam. Although two rows of steam separators 28 are shown, it should be appreciated that any suitable number of separators could be used.

The steam separators 28 define what is referred to in this specification as a steam drying zone 26 in the upper region of the steam generator 16. The steam drying zone 26 is the region of the steam generator 16 within which moisture droplets are removed from the wet steam by the steam separators 28 so as to generate substantially dry steam. The steam separators 28 are at least partly located within the steam drying zone 26.

The steam generator 16 further comprises a depressurization valve 30 which is operable to depressurize the steam generator 16. The valve 30 may be operated by a motor or solenoid system, or via a remote control system, for example. In other arrangements, the valve 30 may comprise an electro-mechanical valve which may open automatically on loss of electrical power. The depressurization valve 30 can be operated to route the steam to a subsidiary location (i.e. a location or to equipment that is not the main turbine 20. The subsidiary location may be the reactor containment, the external atmosphere, a separate tank, an ultimate heat sink, or a local ultimate heat sink (which is described below).

The nuclear power plant 10 further comprises a local ultimate heat sink (LUHS) in the form of a coolant reservoir 29. The local ultimate heat sink 29 is distinct from the ultimate heat sink 21 and is provided close (i.e. local) to the reactor pressure vessel 11. In this arrangement the coolant reservoir 29 is a water reservoir and contains a volume of water. However, it should be appreciated that other fluid coolants could be used. As will be described in detail below, the coolant reservoir 29 can be used to draw heat away from the primary fluid circuit 14 in emergency conditions. Such an emergency condition may occur where the secondary fluid circuit 18 is not capable of drawing heat away from the primary fluid circuit 14. This could be because either fluid is not circulating in the secondary fluid circuit 18, or because the ultimate heat sink 21 is not appropriately cooling the secondary fluid. Such an emergency may occur when there is a power outage. In this arrangement the coolant reservoir 29 is provided outside of the reactor chamber 24 such that there is a physical barrier (e.g. a containment barrier) between the reactor chamber 24 and the reservoir 29. However, in alternative arrangements the coolant reservoir 29 may be provided within the reactor chamber 24.

The bottom of the reservoir 29 is fluidically connected to the bottom of the steam generator 16 by a feed conduit 38. The feed conduit 38 is provided with a valve 34, for example an electromechanical valve, which under emergency conditions opens (or can be opened) such that coolant within the reservoir 29 is supplied to the steam generator 16 under gravity. The upper region of the coolant reservoir 29 is also provided with a breather valve 36 which can be opened to provide fluid communication between the coolant reservoir 29 and the atmosphere (or external environment), thereby equalising the pressure between the inside and the outside of the reservoir 29. This may assist in the flow of coolant from the reservoir 29 to the steam generator 16 in emergency conditions.

The coolant reservoir 29 is filled with coolant, which in this arrangement is water, to a fill level that ensures that when coolant is gravity-fed to the steam generator 16 (i.e. by opening valves 30, 34, 36) the coolant does not rise above a threshold level 32 defined by the steam drying zone 26. In this arrangement the threshold level 32 is at a position below the top of the steam separators 28 and above the bottom of the steam separators 28. The threshold level 32 is selected to ensure that, providing the coolant stays below the threshold level 32, the steam separators 28 appropriately function so as to dry the generated steam. This ensures that even under emergency conditions when the steam generator 16 is flooded with coolant from the reservoir 29, dry steam is generated.

In this arrangement the coolant reservoir 29 is filled to a level that is at or below the threshold level 32. This ensures that when coolant 29 is fed to the steam generator 16 under gravity the coolant 29 does not exceed the threshold level 32. However, it should be appreciated that the coolant reservoir 29 could be filled above the threshold level 32, whilst still ensuring that under emergency conditions the coolant remains below the threshold level 32. Specifically, the coolant reservoir 29 may be filled with coolant to a level above the threshold level 32 such that the volume of coolant in the coolant reservoir 29 above the threshold level 32 is no more than the volumetric capacity of the steam generator 16 below the threshold level 32. In an alternative arrangement the steam generator 16 could be provided with an overflow that, under emergency conditions, prevents coolant from rising above the threshold level 32.

In an emergency condition, for example if there is a power outage, it may no longer be possible to sufficiently cool the fluid within the primary circuit 14. This may be because it is no longer possible to pump the fluid within the secondary circuit 18 and/or because the secondary fluid may not be sufficiently cool. In such cases it is critical to ensure that the reactor pressure vessel 11 does not overheat. On detection of an emergency condition, the valves 30, 36, 38 all open. This may be automatic, or an operator may have to open the valves in response to the detection of an emergency condition. For example, one or more of the valves 30, 36, 38 may be electromechanical and configured such that in the case of a power outage the valves automatically open. Opening the depressurisation valve 30 causes the pressure within the steam generator 16 to drop, and also ensures that any steam generated is routed to a subsidiary location. Opening the breather valve 36 provides fluid communication between the coolant reservoir 29 and the atmosphere and therefore equalises the pressure. Opening the valve 34 causes the coolant (in this arrangement water) to gravity flow into the steam generator 16. The coolant, in the form of water, is turned into steam by the primary circuit 14, thereby removing heat from the primary circuit 14 and the reactor pressure vessel 11. Since the coolant remains below the threshold level 32, the steam separators 28 function appropriately to dry the steam (i.e. remove water droplets from the wet steam) such that the steam leaving the steam generator 16 is substantially dry steam.

As the steam leaving the steam generator 16 is substantially dry, more heat is removed from the steam generator 16 for the same volume of water. This may mean that less water is needed to achieve the same cooling than would be needed if the steam leaving the steam generator 16 was wet. Accordingly, it may be possible to provide a smaller coolant reservoir 29 (containing a smaller volume of water) in order to cool the reactor pressure vessel 11 for a set period of time (e.g. to thermal roll-over). Alternatively, of course, the same size reservoir 29 could be used to cool the reactor pressure vessel 11 for a longer period of time. The coolant reservoir 29 may be sized to provide the total heat sink requirements for decay heat removal over extended periods of time from the immediate shut down state through to thermal roll-over of a nuclear plant without any intervention or power requirements.

In an alternative arrangement shown in FIG. 3, the coolant reservoir 29 may be an annular coolant reservoir 29 that circumferentially surrounds the steam generator 16, reactor plant arrangement or reactor containment structure. Such an arrangement may allow the reservoir 29 to be appropriately sized, whilst keeping the level below the threshold level 32.

In the above described arrangement there is only a single steam generator 16. However, it should be appreciated that there could be multiple steam generators 16. Each could be provided with their own coolant reservoir 29 (or LUHS), or one coolant reservoir 29 could supply multiple steam generators 16.

Although the steam generator 16 shown in a vertical steam generator, the arrangement described is equally applicable to a horizontal steam generator.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A nuclear power plant, comprising:
a reactor pressure vessel;
a steam generator arranged to generate steam utilising thermal energy generated within the reactor pressure vessel;
a fluid circuit for transferring thermal energy from the reactor pressure vessel to the steam generator; and
a coolant reservoir for storing coolant for supply to the steam generator under gravity in emergency conditions;
wherein the steam generator comprises a steam drying zone comprising one or more steam separators configured to dry steam; and
wherein the steam generator and coolant reservoir are configured such that when coolant is supplied from the coolant reservoir to the steam generator in emergency conditions the coolant stays below a threshold level defined by the steam drying zone.

2. The nuclear power plant according to claim 1, wherein the threshold level is set such that, provided that the coolant stays below the threshold level, the or each steam separator functions to dry steam within the steam generator.

3. The nuclear power plant according to claim 1, wherein the threshold level is defined by a lower limit of the steam drying zone.

4. The nuclear power plant according to claim 1, wherein the or each steam separator at least partially lies within the steam drying zone.

5. The nuclear power plant according to claim 1, wherein the coolant reservoir contains coolant.

6. The nuclear power plant according to claim 5, wherein the level of the coolant within the coolant reservoir is at or below the threshold level.

7. The nuclear power plant according to claim 1, wherein the coolant reservoir is located inside a reactor containment.

8. The nuclear power plant according to claim 1, wherein the coolant reservoir circumferentially surrounds the steam generator.

9. The nuclear power plant according to claim 1, wherein the coolant reservoir is provided with a valve operable to provide fluid communication between the coolant reservoir and the outside thereof.

10. The nuclear power plant according to claim 1, further comprising a depressurisation valve operable to reduce the pressure within the steam generator.

11. The nuclear power plant according to claim 10, wherein the depressurisation valve is operable to route steam to a subsidiary location.

12. A method of operating a nuclear power plant in accordance with claim 1, the method comprising supplying coolant from the coolant reservoir to the steam generator under gravity, the coolant remaining below the threshold level defined by the steam drying zone.

13. The method according to claim 12, further comprising opening a valve so as to provide fluid communication between the coolant reservoir and the outside thereof.

14. The method according to claim 12, further comprising opening a depressurisation valve so as to reduce the pressure within the steam generator.

15. The method according to claim 14, wherein opening the depressurisation valve routes steam to a subsidiary location.
